(19) United States
(12) Patent Application Publication
(10) Pub. No.: US 2026/0233247 A1
(43) Pub. Date: Aug. 13, 2026

(54) VIBRATING MESH ATOMIZERS

(71) Applicant: Nathan Morrow Jackson, Rio Rancho, NM (US)

(72) Inventor: Nathan Morrow Jackson, Rio Rancho, NM (US)

(21) Appl. No.: 19/292,696

(22) Filed: Aug. 6, 2025

Related U.S. Application Data
(60) Provisional application No. 63/680,386, filed on Aug. 7, 2024.
(60) Provisional application No. 63/681,492, filed on Aug. 9, 2024.

(51) Int. Cl. B05B 17/00; B05B 17/06; B64G 1/40

(52) U.S. Cl. CPC B05B 17/0638; B05B 17/0661; B05B 17/0684; B64G 1/415

(57) ABSTRACT

A variety of applications can include silicon-based vibrating mesh atomizer (Si-VMA) including inhaled delivery of an aerosol or vaping. Applications can include a Si-VMA with a mesh membrane having an arrangement of apertures structured as nozzles and a mesh wick integrated with the Si-VMA and arranged on the mesh membrane. Applications can include a Si-VMA with a mesh membrane having an arrangement of apertures structured as nozzles and having the nozzles arranged in sections of nozzles to operate the silicon-based vibrating mesh atomizer in multiple modes for propulsion of a microthruster. A chamber can be located on the mesh membrane and can be partitioned into sub-chambers to hold multiple propellants such that each sub-chamber is on a different section of the sections of nozzles.

### CLAIM OF PRIORITY

This application claims the priority benefit of U.S. Provisional Application Ser. No. 63/680,386, filed 7 Aug. 2024, entitled “VIBRATING MESH ATOMIZER WITH INTEGRATED WICKING AND METHOD OF MAKING THE SAME” and U.S. Provisional Application Ser. No. 63/681,492, filed 9 Aug. 2024, entitled “VIBRATING MESH ATOMIZER MICRO-THRUSTER PROPULSION SYSTEM,” which applications are incorporated herein by reference in their entireties.

### FIELD OF THE INVENTION

The invention relates generally to vibrating mesh atomizers.

### BRIEF DESCRIPTION OF THE DRAWINGS

Embodiments are illustrated by way of example and not limitation in the figures of the accompanying drawings in which:

FIG. 1 is a schematic of vibrating mesh atomizer mechanism of action, in accordance with various embodiments.

FIG. 2A illustrates integration of a vibrating mesh atomizer with electro-wicking with a micro-lattice with respect to an e-liquid wicking, in accordance with various embodiments.

FIG. 2B shows a top view of the silicon-based vibrating mesh atomizer with an integrated micro-lattice wick of FIG. 2A.

FIGS. 3A-3I illustrate an example of a microfabrication process flow for forming a silicon-based vibrating mesh atomizer with an integrated wick, in accordance with various embodiments.

FIG. 4A is a representation of electro-wicking operation of an example mesh wick, in accordance with various embodiments.

FIG. 4B is another representation of electro-wicking operation of an example mesh wick, in accordance with various embodiments.

FIG. 4C is a representation of wicking and de-wicking with a mesh wick on a mesh membrane of a silicon-based vibrating mesh atomizer, according to the on or off status of a voltage supply, in accordance with various embodiments.

FIG. 4D is a top view representation of the mesh wick over nozzles of the mesh membrane of FIG. 4C, in accordance with various embodiments.

FIG. 4E shows the time associated with wicking using an arrangement discussed with respect to FIGS. 4A-4D, in accordance with various embodiments.

FIGS. 5A-5C illustrate a mesh wick, in accordance with various embodiments.

FIG. 6 illustrates a set of nozzles of a mesh membrane of a silicon-based vibrating mesh atomizer, where each nozzle has a hydrophilic surface and a hydrophobic surface, in accordance with various embodiments.

FIG. 7 is a flow diagram of features of an example method of forming an apparatus having a silicon-based vibrating mesh atomizer, in accordance with various embodiments.

FIG. 8 shows single use microelectromechanical systems vibrating mesh atomizer, in accordance with various embodiments.

FIG. 9 shows a thrust of droplets from the mesh membrane of FIG. 8, in accordance with various embodiments.

FIG. 10 shows a droplet analysis of a silicon-based vibrating mesh atomizer, in accordance with various embodiments.

FIG. 11 shows microthruster propulsion performance regions with respect to specific impulse versus thrust for several propulsion types, in accordance with various embodiments.

FIGS. 12-15 show schematics of propulsion modes for microthrusters, in accordance with various embodiments.

FIG. 16 illustrates an example microthruster with a silicon-based vibrating mesh atomizer having multiple thruster modes in a single device, in accordance with various embodiments.

FIG. 17 illustrates an example electrospray electrode configuration in a silicon-based vibrating mesh atomizer, in accordance with various embodiments.

FIG. 18 illustrates an example combustion configuration for a silicon-based vibrating mesh atomizer, in accordance with various embodiments.

FIG. 19 illustrates an example resistorjet thruster configuration, in accordance with various embodiments.

FIG. 20 is a top view of an example silicon-based vibrating mesh atomizer having a mesh membrane configured to accommodate four different microthruster modes and four different liquids, in accordance with various embodiments.

FIG. 21 is a flow diagram of features of an example method of forming a microthruster, in accordance with various embodiments.

### DETAILED DESCRIPTION

The following detailed description refers to the accompanying drawings that show, by way of illustration and not limitation, various example embodiments of the invention. These embodiments are described in sufficient detail to enable those skilled in the art to practice these and other embodiments. In order to avoid obscuring embodiments, some well-known system configurations and process steps are not disclosed in detail. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Portable vaping devices, which were initially developed as a safer alternative to smoking and have been an effective smoking cessation tool, recently have been used to deliver therapeutic inhaled cannabis (cannabidiol (CBD) or tetrahydrocannabinol (THC)). Initially vaping was believed to be 95% safer than traditional cigarettes, due to the reduced combustion-related carcinogens. However, all vaping tools operate via pyrolysis (vaporization) of liquids requiring high temperatures (HT) (150-315° C.). Liquid that is converted into an aerosol by a vaping product is referred to as an e-liquid. Further, HT heating can alter the chemical composition of e-liquids resulting in potentially toxic chemical compounds including formaldehyde, acrolein, acetaldehyde, glycidol and other toxicants with known long-term cardiovascular, respiratory, and other health risks. Byproducts generated from current vaping tools include volatile organic compounds, nicotine, ultrafine particles, cancer causing chemicals, heavy metals, and chemical flavors linked to lung disease. Associated health effects from such byproducts can include kidney failure, oral cancer, cardiovascular disease, oxidative stress, lung cancer, sinonasal problems, respiratory problems, neurotoxicity.

The therapeutic effects of inhaling cannabis-based drugs have been well documented including treatment of anxiety, epilepsy, and neuropathic pain management. Inhaling cannabis has a faster response time and is easier to control the dose than edibles, but smoking cannabis results in combustible toxic products such as ammonia, hydrogen cyanide, and carcinogens. Nebulizers can deliver inhaled drugs, but they have poor droplet size control, which leads to variable dose delivery, they cannot atomize oils without special emulsion liquids, and they are not portable. Due to these issues users have switched to vaping tools to inhale CBD,

THC, or nicotine, but vaping is not recommended by the Centers for Disease Control (CDC) due to their HT requirements, which can alter the chemical composition of the liquid. It is often not known what the user is inhaling, making Food and Drug Administration (FDA) regulation of e-liquids difficult.

Current vaporizers are basically a chemical reactor, with HT applied to the liquid resulting in the production of harmful chemicals. In addition, aerosols have been found to have increased metallic particles (Cr, Ni, Sn, Pb, Al, and other metallic particles) due to the metallic coils needed to apply the HT, which have been linked to fatal conditions like lung cancer. Vaping also produces ultra-fine particles 10-200 nm, which can agglomerate and cause increased respiratory and cardiovascular risks. Therefore, reduction of ultrafine particles with reduced span (0.5-2 μm) is also highly desired to reduce health risks. In particle size analysis, span is a measure of the width or spread of a particle size distribution. A smaller span indicates a narrower distribution, where the particles are more uniform in size, while a larger span suggests a wider distribution with more variation in particle sizes. The span can give a quantitative value for the distribution of droplet sizes.

Vaping has three major health risks: 1) chemicals produced from thermal reactions, 2) metal particles from coils, and 3) ultra-fine particles, which have all been linked to long-term health risks. However, despite the health risks the demand for vaping continues to increase for therapeutic, cessation, and recreation use. Development of a next-generation alternative vaping device may provide a “safer” alternative vaping device that will reduce or eliminate long-term health risks. However, this is not possible using current Joule heating vaping technology.

In various embodiments, a silicon-based mechanical atomizer, based on ultrasonic vibrating mesh atomizer (VMA) technology, can address these issues. A silicon-based VMA is referred herein as a Si-VMA. Such a Si-VMA can be structured as a low-temperature atomizer device with one or more operational characteristics to: i) reduce toxic chemical byproducts, ii) reduce ultrafine particles, or iii) eliminate metal particles in the aerosol generated by the Si-VMA.

Traditional metallic VMAs are currently used in nebulizers at room temperature and have good droplet size uniformity control, with a span in the range of 1-3, but they are limited to low viscosity liquids (<2 cP) due to force limitations. The Si-VMA, as taught herein, can have the capability of atomizing higher viscosity e-liquids (2-150 cP) at room to low temperatures (20-50° C.). The Si-VMA can achieve these characteristics by increasing atomization threshold or reducing liquid viscosity/density. Increasing atomization threshold can be approached by i) integration of an electro-wicking technology to increase wettability on demand (reduce surface tension), where wettability is the preference of a liquid to be in contact with a solid surrounded by another fluid (liquid or gas), and ii) optimization of a piezoelectric configuration to maximize force. Electro-wicking refers to the phenomenon in which an electric field influences the movement of liquids. A wick is material that by capillary attraction draws up a liquid, where the material can be, but is not limited to a bundle of fibers or a loosely twisted, braided, or woven cord, tape, or tube. Reduction of liquid viscosity/density can be realized through the integration of a low-temperature (<50° C.) μ-heater. The inventor hypothesizes that reduced temperature atomization will result in the aerosol having the same chemical composition as the initial liquid, thus reducing potential health risks and making regulation of e-liquids easier. Ideally, an approach is to eliminate any elevated temperatures, but even reducing the temperature to 20-50° C. from 315° C. for vaping should have reduced risks.

Vaping tools work by vaporizing the liquid though heat (150-315° C.). The temperature and power can be varied based on power (9-200 W) and coil resistance. Alternative atomizers used in therapeutic nebulizers include nebulizers based on ultrasonics, air pressure, and surface acoustic wave. However, these methods require high power (>40 W), are not portable, and have poor droplet size distribution resulting in ultrafine droplets less than 500 nm and large droplets greater than 2.5μm; thus, they are not good alternatives for vaping. A recently developed ultrasound-based atomizer still requires temperatures greater than 150° C. and can only operate using custom e-liquids.

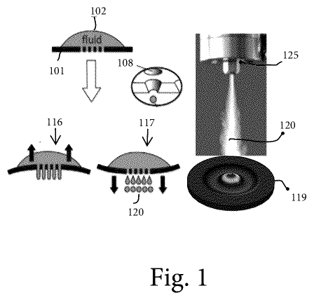

FIG. 1 is a schematic of VMA mechanism of action. The VMA that can be used with e-liquids. VMAs produce an aerosol via high frequency (100-200 kHz) mechanical vibrations rather than heat and were developed for nebulizers to provide excellent control of droplet size distribution (>80% of fine particle droplets) and low power (<2 W) making portability feasible. The mechanism of action is based on a vibrating membrane with a large number of nozzles, which oscillate via actuation of a piezoelectric film. The array can have greater than one thousand nozzles.

FIG. 1 represents a VMA in which operation of a piezoelectric actuator 101 is used with respect to a fluid 102. A droplet 120 can be provided from hole 108 by fluid 102 by operation of piezoelectric actuator 101. Piezoelectric actuator 101 can be used to provide a push 116 that generates droplets 120 and a pull 117 that generates droplets 120. An aerosol 120 can be provided from a nozzle 125 coupled as a final output to the output holes 108 of piezoelectric actuator 101 encased as a portal device. In an example, nozzle 125 can be part of a mouthpiece. VMAs operate in a higher vibrational mode (02 mode 119) with higher force than ultrasound or inkjet operating in a 01 mode. If the high central force from the 02 mode 119, is greater than surface tension, the liquid is squeezed through the nozzles producing droplets with similar dimensions as the outlet nozzle.

The flow rate of a VMA is typically greater than 0.005 ml/s, which is comparable to vaping (0.003 ml/puff). However, current metallic VMAs can only atomize low viscosity liquids (<2 cP) due to their low stiffness and poor nozzle design, which is limited by manufacturing capabilities. This viscosity limitation is not compatible with current e-liquids that have viscosities in the range of 25-150 cP. VMA atomization is dependent on viscosity, density, and surface tension.

In various embodiments, this challenge can be overcome by a Si-VMA to increase the threshold viscosity for atomization by i) integrating low-temperature μ-heaters (<50° C.) to reduce the liquid viscosity/density, ii) integrating electro-wicking technology to alter wettability on demand thus reducing atomization threshold, iii) optimizing piezoelectric design to maximize membrane force, or iv) combinations thereof. Integrating features in a Si-VMA can be a monolithic process in which the features are structured using semiconductor processing techniques to form the features on the same die as the Si-VMA.

The inventor has developed Si-VMA atomizers for nebulizers with a 15 cP (60% Glycerol) threshold without any enhancement methods. The 7.5x increase of the Si-VMA over metallic VMA is due to higher stiffness of Si which produces larger forces and its unique tapered (54.7°) nozzle shape. Enhancing the wettability and force, an increase in atomization threshold to greater than 50 cP is estimated, which would allow one to atomize propylene glycol (PG) and medium-chain triglycerides (MCT) at room temperature, but atomization of vegetable glycerin (VG) will use additional low temperature heating to reduce the viscosity. Combining methods should allow one to atomize all e-liquids with temperatures less than 50° C., which the inventor hypothesizes will not alter the chemical composition of the liquid. Si-VMAs also have demonstrated significantly improved droplet distribution (span<1). Metallic VMA would require temperatures greater than 150° C. to reduce the viscosity below the threshold, which would likely result in similar byproduct generation as vaping; thus, metallic VMA are not suitable.

In various embodiments, a Si-VMA incorporates an electro-wicking technology, which can also take into account that atomization is also dependent on surface tension. The electro-wicking technology can be based on electrowetting, where electrowetting is a modification of the wetting properties of a surface with an applied electric field. The surface can typically be hydrophobic. The electro-wicking technology of the Si-VMA can include using an octahedral micro-lattice wick, so it combines wick with electrowetting, which can reduce contact angle rapidly (<100 ms) of oils to zero by applying voltage across the liquid. The use of μ-heaters with electro-wicking can also function to unclog nozzles by applying localized HT when not in use to vaporize any clogged liquid. Total power consumption of the Si-VMA with heater and electro-wicking can be less than one watt (due to microelectromechanical systems (MEMS) components), compared to vaporizers having a power consumption in the range from about nine watts to about two hundred watts.

Si-VMA advantages can include: i) integration of one or more μ-heaters to enable atomization of high viscous liquids, ii) optimized nozzle shape to reduce ultrafine particles, iii) integration of electro-wicking, iv) integration of pressure and thermal sensors for enhanced control, and v) batch fabrication compatibility (manufacturing costs less than $5), which is comparable to vaping coils, and vi) low power consumption of less than one watt. Integration can be a monolithic process in which the features are structured using semiconductor processing techniques to form the features on the same die as the Si-VMA.

There are greater than fifty-five million active vaping users (5% of adults vape daily), which continues to increase, and over five million teenage users. Based on recent health risk findings, this has significant long-term health implications. In 2020, there were more than 2800 hospitalizations and 68 deaths due to vaping. With more states legalizing THC products, this number is expected to continue to increase. Therefore, a safer alternative atomization method is appropriate to protect users, especially young adults, from developing long-term health risks. The VMA taught herein can be a tool to provide users with a safer alternative. The broader impacts of developing a high viscosity atomizer can be beneficial to applications including pharmaceutical dry powder generation, new nebulizer therapeutic treatment with suspensions, additive manufacturing, spray cooling and other applications.

Compared to current metallic VMAs or previous Si-VMAs, the device taught herein can include electro-wicking technology. In variations of such a VMA can include an integrated heater or added microfluidics to atomize multiple liquids at specific times. Electro-wicking technology with combinations of an integrated heater and microfluidics are not feasible with previously developed Si-VMAs, metallic VMAs, or vaping devices. Previously developed Si-VMA used commercial piezoelectric ring. In an integrated Si-VMA a thin film sol-gel can be deposited PZT to maximize force output from the Si-VMA. Si-VMAs, as taught herein can provide a high viscous liquid atomizer with low-temperature requirements, small droplet span, and controlled droplet size. Currently, no such atomizer exists that can accomplish all three of these challenges.

Si-VMAs with integrated heaters can be operated with reduced heating for atomization with respect to high viscosity liquids in a temperature range from about 25° C. to about 50° C. compared to current vaporization in the range of about 150° C. to about 315° C.- 315 C) or ultrasound operation in at temperatures greater than about 150° C. Si-VMAs with electrowetting can provide a device having a high-viscosity threshold for operation. Electrowetting can be applied to microfluidics for on-demand wettability control. Wicking can be used for atomizers to reduce the volume of liquid at the interface. Si-VMAs, as taught herein, can include combination of electrowetting and wetting that can on-demand controllability and can be reversible (reduced surface tension when voltage is applied). In addition, piezoelectric material configuration for the actuator of the mesh membrane of the Si-VMA can be optimized into multiple ring designs to match 02 and 03 circular modes to increase force. Increasing force and reducing surface tension forces can increase atomization threshold without the use of heat. A Si-VMA capable of handling high viscosity liquids can be advantageous for numerous applications, such as e-cigarettes, therapeutic drug delivery (oils and viscous liquids), and spray-drying.

Currently e-liquids are poorly regulated, as there are thousands of different chemical mixtures available. Vaporization makes regulating these liquids difficult as the heat alters the aerosol chemical composition in aerosols, which varies based on temperature. For instance, vitamin E is safe but when heated (>150 °C) produces toxic vitamin E Quinone. A Si-VMA operable at temperatures considerably below 150° C. can generate an inhaled aerosol that better matches the chemical composition of the initial liquid, thus making regulations of liquids more manageable. In addition, such a Si-VMA can be used to develop aqueous-based formulations that further eliminate potential to generate toxic byproducts and to study chemical composition effects as a function of temperature.

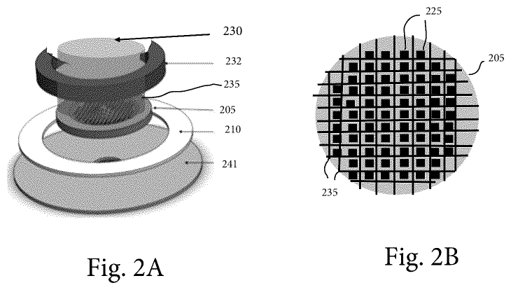

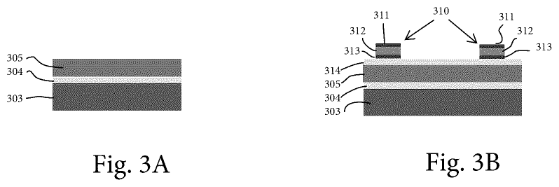

FIG. 2A illustrates integration of a VMA with electro-wicking with a micro-lattice with respect to an e-liquid wicking 230. A Si-VMA can be positioned on a holder 241 and can include a mesh membrane 205 to be actuated by a piezoelectric film 210. Mesh membrane 205 can be a silicon mesh with holes (apertures) structured as nozzles. Piezoelectric film 210 can have, but is not limited to, a ring structure coupled to mesh membrane 205. A mesh wick 235 can be positioned on mesh membrane 205. Mesh wick 235 can be integrated on mesh membrane 205 having a mesh structure designed with respect to an array of the nozzles of mesh membrane 205. Alternatively, an individual wick can be structured with respect to an individual nozzle. E-liquid wicking 230 can be positioned within a spacer 232. FIG. 2B shows a top view of the Si-VMA with an integrated micro-lattice wick of FIG. 2A. A plane of mesh wick 235 is shown on nozzles 225 of mesh membrane 205.

Finite element modelling (FEM) simulation can be used to optimize nozzle shape and piezoelectric/electrode configuration to maximize the force to overcome surface tension by using multiple ring designs and measuring velocity and displacement of the membrane in 02 mode. Increased wettability is favorable for atomization according to the Ohmesorge number. The Ohnesorge number (Oh) is a dimensionless number that relates the viscous forces to inertial and surface tension forces. Increasing wettability of nozzles to reduce contact angles can be accomplished by first soaking the Si membrane in liquid tetraethyl orthosilicate (TEOS) to provide an abundance of Si—O—Si groups on the surface. Then, a silane-coupling agent can be coated on the surface to form a long-lasting SiOH layer resulting in a superhydrophillic surface with contact angles less than 10°. Superhydrophobic surfaces can be created having contact angles greater than 120°. Varying the hydrophobicity properties at both the inlet and outlet nozzles can affect the atomization threshold. A micro-heater (μ-heater) can be integrated with the VMA of FIG. 2A, though not shown. With respect to a μ-heater, FEM designs to optimize the μ-heater performance can be implemented for spatial heat distribution, response rates, and power consumption.

Heaters can be fabricated using a polyimide substrate to minimize thermal expansion (CTE) mismatches. Titanium/Platinum (Ti/Pt) (20/200 nm) can be deposited and patterned using lift-off techniques. Example thickness of the Ti/Pt can include, but is not limited to, 20 nm/200 nm. A thin (for example, 1 μm) insulating layer of Parylene-C can be deposited to eliminate potential of Ti/Pt particles in aerosol. The designed heaters'performance can be characterized. Expected performance results of the heaters, based on based on FEM, can include response time of less than 100 ms and power of less than 0.3 W to heat liquid to 70° C.

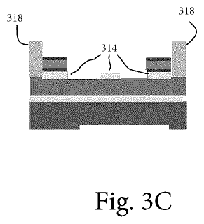

FIGS. 3A-3I illustrate an embodiment for a microfabrication process flow for forming a Si-VMA with integrated wick. The atomizer can include a silicon membrane with etched nozzles made from a silicon-on-insulator wafer. FIG. 3A shows a silicon-on-insular (SOI) wafer from which a Si-VMA with wicking is to be formed. The SOI wafer has a device silicon 305 on and contacting an oxide layer 304, where oxide layer 304 is on and contacting a silicon handle 303. Oxide layer 304 can be a silicon oxide layer.

FIG. 3B shows a structure formed from processing the structure of FIG. 3A. A dielectric layer 314, such as but not limited to a silicon oxide layer, has been formed on and contacting device silicon 305. Dielectric layer 314 can be thermal SiO2 can be grown on the SOI wafer and latter patterned as an etch mask. A tetraethyl orthosilicate (PZT) ring 310 has been formed on and contacting dielectric layer 314 and situated above device silicon 305. PZT ring 310 has been formed with PZT 312 sandwiched between conductive electrodes 311 and 313. Conductive electrodes 311 and 313 can be metal electrodes, which can include but is not limited to Pt. A PZT piezoelectric configuration for PZT ring 310 can be deposited using a sol-gel process to maximize the velocity.

FIG. 3C shows a structure formed from processing the structure of FIG. 3B. Dielectric layer 314 has been etched, forming openings to device silicon 305 and spacers 318 have been formed. Spacers can be SU-8, which is an epoxy-based negative photoresist. Negative refers to a photoresist in which the parts exposed to UV become cross-linked. A SU-8 spacer can be spin coated and patterned on the device silicon 305, which is to be the silicon membrane of the Si-VMA formed. The spacer thickness can be optimized to reduce the amount of liquid at the nozzle interface, which lowers the force needed to atomize the liquid and can increase heat transfer rates from a μ-heater implemented.

FIG. 3D shows a structure formed from processing the structure of FIG. 3C. Nozzles 325 have been formed by removing material from device silicon 305 using dielectric layer 314 and PZT ring 310 as masks. Removing material from device silicon 305 to form nozzles 325 can be realized by an etching process. Etching the nozzles can depend on the optimal shape determined by, for example, simulation. The etching process can include KOH anisotropic etching (54.7° taper), isotropic etching (XeF₂), straight etch (deep reactive ion etching (DRIE)) or a combination of these. The outlet nozzle dimensions can be 0.5-2 μm in diameter to control droplet size distribution. Other etching processes may be used and other dimensions for the components of the Si-VMA can be made. The nozzle sidewalls can be coated in metal and insulated with parylene to act as electrode for electro-wicking.

FIG. 3E shows a structure formed from processing the structure of FIG. 3D. Hydrophilic coating 322 has been formed on the inner surfaces of nozzles 325, proving a hydrophilic coating to the inlets of nozzles 325.

FIG. 3F shows a structure formed from processing the structure of FIG. 3E. Silicon handle 303 has been etched forming opening 327. Silicon handle 303 can be etched using DRIE. Opening 327 provides an output volume for nozzles 325.

FIG. 3G shows a structure formed from processing the structure of FIG. 3F. Hydrophobic coating 323 has been applied to bottom surfaces of device silicon 305 around outlets of nozzles 325.

FIG. 3H shows a structure formed from processing the structure of FIG. 3G. A mesh wick 335 has been formed to the inlets of nozzles 325. Mesh wick 335 can include an octahedrally 3D printed micro-lattice structure with metal coating (electroless) and insulated with parylene. The octahedral shape can fit in a nozzle 325 and can have an optimized design for wicking the structure can include an array to cover each nozzle. Mesh wick 335 can have a shape other than an octahedral lattice. The metal coating can be formed by using electroless coating or atomic layer deposition (ALD).

FIG. 3I shows a structure formed from processing the structure of FIG. 3H. A chamber having walls 334 on bottom base 336 that has been formed on spacers 318 with openings to the region that includes PZT ring 310, mesh wick 335. The chamber can be structured to hold and provide bulk liquid 302 such as an e-liquid. A top electrode 340 has been formed to provide electro-wicking of bulk liquid that flows to the region that includes PZT ring 310, mesh wick 335. Actuation of PZT ring 310 can vibrate device silicon 305 formed into a silicon membrane by the formation of nozzles 325, producing aerosol droplets 320 from liquid that has been provided from the chamber and subjected to electro-wicking using mesh wick 335.

A variation to the process flow can include formation of a μ-heater. Heater fabrication can include a metal layer deposited on backside to act as top electrode 340 in the electro-wicking operation of Si-VMA. The fabricated heater can be bonded to spacer 318. Electro-wicking provides the advantages of a wick and electrowetting for on demand reversible control of wettability (surface tension) to increase atomization threshold. The parameters of forming the Si-VMA can be optimized to increase the atomization threshold. A target atomization can include a high-viscosity threshold to at least greater than 50 cP but ideally greater than 150 cP to reduce or eliminate the need for heating the liquid.

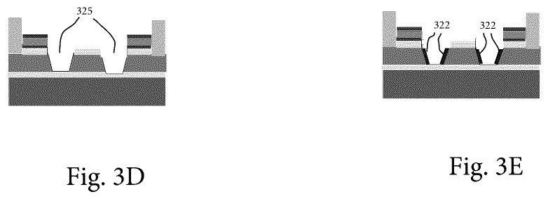

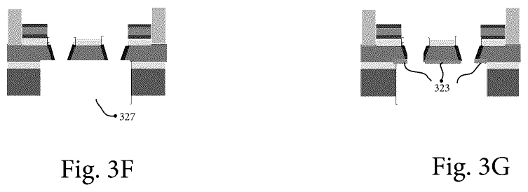

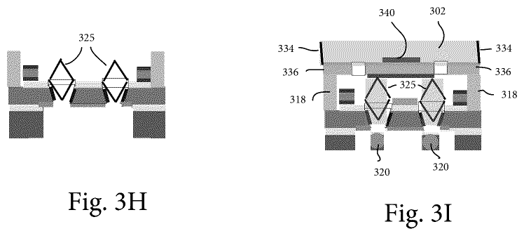

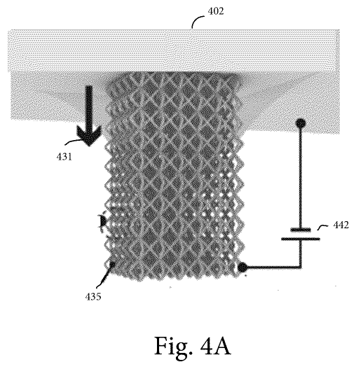

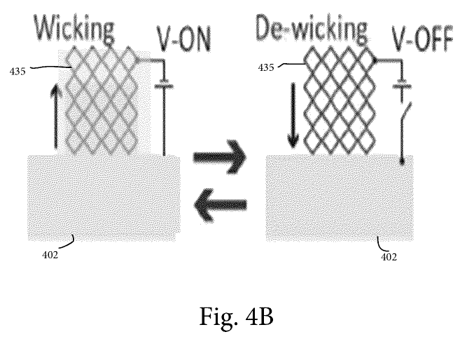

FIG. 4A is a representation of electro-wicking operation of an embodiment of an example mesh wick 435 similar to mesh wick 235 of FIG. 2A and mesh wick 335 of FIG. 3I. Under an electric field provided by voltage supply 442 coupled to e-liquid 402 at the top of mesh wick 435 and to the bottom of mesh wick 435, electro-wicking of e-liquid in direction 431 through mesh wick 435 is provided. Mesh wick 435 is a 3D structure that can provide controlled wetting.

FIG. 4B is another representation of electro-wicking operation of an embodiment of example mesh wick 435 similar to mesh wick 235 of FIG. 2A and mesh wick 335 of FIG. 3I. With a voltage applied, there is wicking in the direction from e-liquid 402 through mesh wick 435. With no applied voltage, there is de-wicking in the direction from mesh wick 435 to e-liquid 402. FIG. 4C is a representation of wicking and de-wicking with mesh wick 435 on mesh membrane 405 of a Si-VMA, according to the on or off status of a voltage supply 442. FIG. 4D is a top view representation of mesh wick 435 over nozzles 425 of mesh membrane 405 of FIG. 4C. FIG. 4E shows the time associated with wicking using an arrangement discussed with respect to FIGS. 4A-4D.

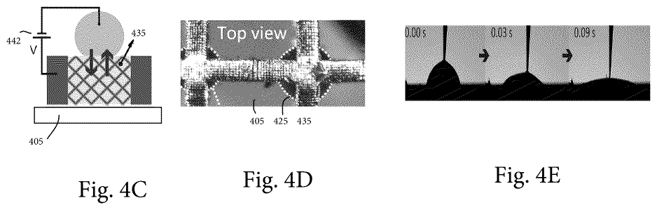

FIGS. 5A-5C illustrate a mesh wick. FIG. 5A shows a 3D mesh wick having several layers of cell structures of the mesh wick structured as a micro-lattice wick. FIG. 5B is a representation of a cell of the 3D mesh wick of FIG. 5A, illustrating an octahedral cell that can be positioned in a nozzle of a mesh membrane of a Si-VMA. FIG. 5C shows an enhanced view of a cell of the 3D mesh wick of FIG. 5A.

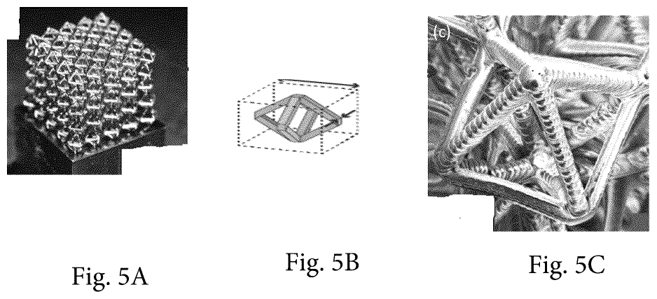

FIG. 6 illustrates a set of nozzles 625 of a mesh membrane of a Si-VMA, where each nozzle has a hydrophilic surface and a hydrophobic surface. A nozzle 635 can have a hydrophilic coating 622 on the inner surfaces of nozzles 625, proving a hydrophilic surface to the inlets of nozzles 625. The inner walls of nozzles 625 can be coated to provide hydrophilic surface using silane or functional groups by chemically coating or by using reactive ion etching. Hydrophilic inner walls of the nozzles can be implemented to increase wettability to allow easier filling of the nozzles.

Nozzle 635 can also have a hydrophobic coating 623 on the bottom surface of nozzle 625. Outlets of nozzles 635 can be coated in a hydrophobic coating 623 to allow the liquid to repel from the surface. Altering the coatings of the surfaces of nozzles can be used to alter the wettability same as the wicking but using different mechanisms. Both hydrophilic coating 622 and hydrophobic coating 623 can be coated using chemical dip coating, spin coating, or similar coating process. Both hydrophilic coating 622 and hydrophobic coating 623 can be added using reactive ion etchers to coat various functional groups such as fluorine based groups for hydrophobic coating and OH groups for hydrophilic coatings.

In various embodiments, an apparatus can include a Si-VMA with wicking capabilities. The Si-VMA can have a mesh membrane, where the mesh membrane has an arrangement of apertures structured as nozzles. The Si-VMA can have an integrated mesh wick arranged on the mesh membrane. The Si-VMA can also include a piezoelectric actuator to vibrate the mesh membrane of the Si-VMA. The piezoelectric actuator can include, but is not limited to, a PZT actuator. The PZT actuator can be structured as a PZT ring.

Variations of such an apparatus or a similar apparatus can include a number of different embodiments that may be combined depending on the application of such an apparatus and/or the architecture of systems in which such apparatus are implemented. Such an apparatus can include the Si-VMA having electrodes to apply a voltage between a top of the mesh wick and a bottom of the mesh wick with the bottom of the mesh wick on and contacting the mesh membrane. Variations can include the mesh wick structured with wick elements having an octahedral shape. The mesh wick can have multiple levels of mesh elements with a first level of mesh elements arranged with the octahedral shape structured to fit into a nozzle. Variation of such an apparatus can include the mesh wick structured as a single layer with wicking in between the nozzles on the mesh membrane. The single layer mesh wick can include cotton, nylon, or other absorbent material.

Variations of such an apparatus or a similar apparatus can include each nozzle having both a hydrophilic surface and a hydrophobic surface. The hydrophilic surface can be along an inner surface between an inlet of the nozzle and an outlet of the nozzle, and the hydrophobic surface can be around the outlet of the nozzle.

Variations of such an apparatus or a similar apparatus can include a heater integrated in the Si-VMA. The heater can be a micro-heater or a nano-heater. The integrated heater can be coupled to an electrode that is coupled to the mesh wick. Such an apparatus or a similar apparatus can include features associated with the structures of FIGS. 1-6.

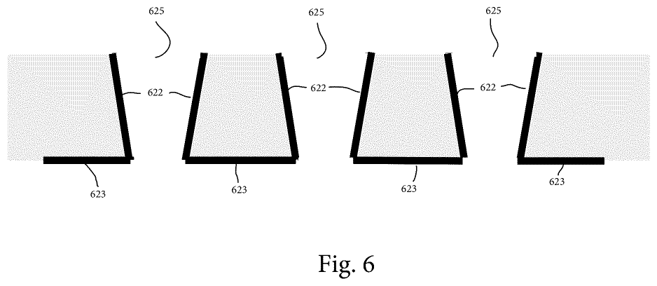

FIG. 7 is a flow diagram of features of an embodiment of an example method 700 of forming an apparatus having a Si-VMA. At 710, a mesh membrane for a Si-VMA is formed. At 720, an arrangement of apertures is formed in the mesh membrane. The apertures are structured as nozzles through the mesh membrane. At 730, a mesh wick is formed arranged on the mesh membrane. The mesh wick can be structured as wick elements connected together to form a mesh. The mesh can be a single layer mesh or a 3D mesh.

Variations of method 700 or methods similar to method 700 can include a number of different embodiments that may be combined depending on the application of such methods and/or the architecture of systems in which such methods are implemented. Such variations can include coating the mesh wick in metal. The mesh can be coated with the metal using an electroless coating or using ALD. Variations can include forming electrodes to the Si-VMA to apply a voltage between a top of the mesh wick and a bottom of the mesh wick with the bottom of the mesh wick on and contacting the mesh membrane.

Variations of method 700 can include structuring the nozzles to have both a hydrophilic surface and a hydrophobic surface. The hydrophilic surface of a nozzle can be formed along an inner surface between an inlet of the nozzle and an outlet of the nozzle, and the hydrophobic surface of a nozzle can be formed around the outlet of the nozzle.

Variations of method 700 can include forming the mesh wick with wick elements having an octahedral shape. The wick elements with the octahedral shape can be formed to fit into a nozzle. Variations can include forming the mesh wick structured as a single layer with wicking in between the nozzles on the mesh membrane. The single layer mesh wick can include cotton, nylon, or other absorbent material.

Variations of method 700 can include forming a heater integrated in the Si-VMA. The heater can be formed as a micro-heater or a nano-heater. The heater can be formed coupled to an electrode that is coupled to the mesh wick. Variations of method 700 can include forming features associated with the structures of FIGS. 1-6.

In various embodiments, wicking can be integrated into VMAs. The VMAs can be Si-VMAs. The wicking can be structured as a single layer mesh that has wicking in between the nozzles on the membrane. The material of the single layer can be, but is not limited to, cotton, nylon, or other absorbent material. The wicking can have a “smart” wicking component that is called electro-wicking. Normal wicking just works by absorbing the liquid, which affects the wettability on the surface. Electro-wicking controls the wettability on demand, such that by turning on and off electrical bias one can cause liquid to flow through or not to flow through the wick, which provides reversible wicking on demand. This alters the wettability or surface tension which is a big part of determining if a liquid can be atomized, where viscosity, surface tension, and density basically determine atomizations. The e electro-wicking can alter the surface tension or wettability.

Electro-wetting can be performed by creating a 3D structure that has an insulated material that has a micro-lattice structure or a nano-lattice structure. The lattice structure can be an octahedral lattice, but other shapes can be implemented. The lattice can be coated in metal to perform the electro-wetting, which coating can be applied, but not limited to, using electroless coating process or ALD. A control system for the electro-wetting can be controlled through a button or an integrated pressure sensor on the mesh membrane that activates the control system upon indication of a pressure change.

Monolithically integrated VMAs can be structured to provide capabilities in other applications such as microthrusters. There is an increasing demand for Cubesat and micro-satellites for planetary observation for measuring aerosols, magnetic field, ocean temperature, ice cover, land topography, and numerous other measurands. CubeSat is a class of miniaturized satellites using a cube with dimensions of 10 cm×10 cm×10 cm (1U) as a standardized form factor. CubeSats are deployed into orbit from the International Space Station or launched as secondary payloads on a launch vehicle. However, currently Cubesats are passive systems with limited maneuverability and no operational attitude control, which significantly reduces their impact and ability to accurately observe these measurands. An integrated propulsion system is needed for attitude control and maneuverability. MEMSs-based microthrusters (MTs) have been investigated as an integrated propulsion system to accomplish these tasks. However, current MEMS-based MTs only operate in a single mode which has disadvantages based on the specific mode. Specific modes include either low thrust, short specific impulse (Isp), short overall thruster duration, complex manufacturing, and toxic propellants.

In various embodiments, a low-cost multi-mode microthruster can provide for high accuracy attitude control for planetary observation. A MT mode of operation that can be implemented that integrates multi-modes into a single MT to combine advantages and reduce disadvantages in a single engine module. The multi-mode MT can be based on VMA technology, which was initially developed to generate aerosols for inhaled drug delivery. The VMA can include a mesh membrane that vibrates via a piezoelectric material, which forces liquid to squeeze through the nozzles creating an aerosol. FIG. 1 illustrates a VMA working principle. VMAs have excellent control over droplet size compared to ultrasonics, jet pressure, or vaporization atomizing methods. However, current VMA technology uses off-the shelf components to assemble the atomizer, which limits its capabilities as only low viscosity (<2 cps) aqueous based liquids can be used. The inventor has invented a silicon MEMS-based VMA, also referred to as a silicon-based VMA or Si-VMA, with enhanced droplet control, reduced power (<1 W), and capability of atomizing liquids up to 10 cps, which is suitable for most liquid propellants.

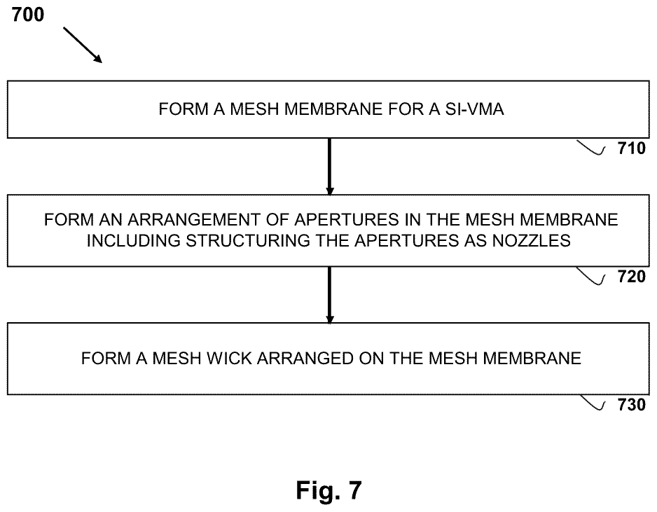

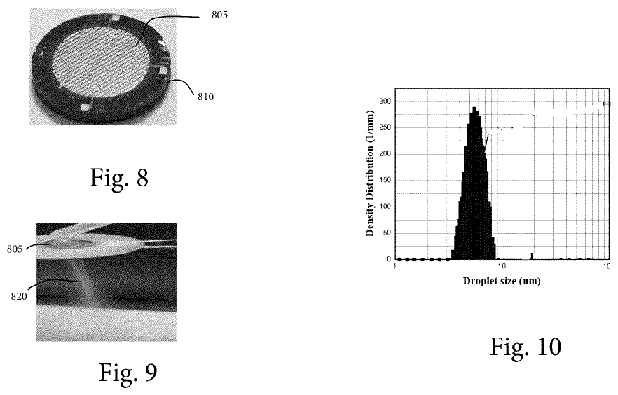

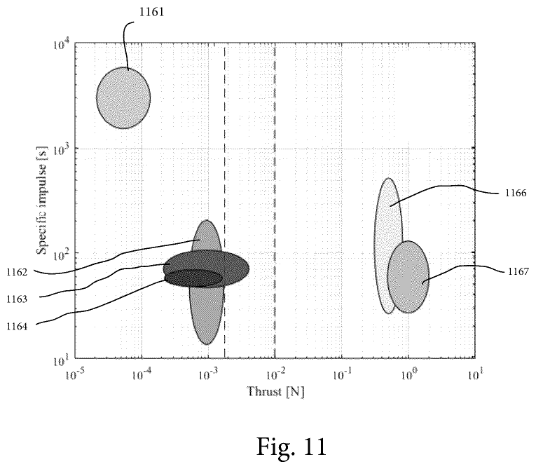

A VMA can be structured to address these disadvantages. FIG. 8 shows single use MEMS VMA having a mesh membrane 805 that responds to a piezoelectric actuator 810 to force droplets into a direction away from outlets of mesh membrane 10. FIG. 9 shows a thrust of droplets 820 from mesh membrane 805 of FIG. 8. FIG. 10 shows droplet analysis of a Si-VMA. The droplet analysis indicates that droplets from the Si-VMA have a relatively narrow range of droplet sizes. FEM demonstrates enhanced atomization by using heaters.

A VMA-based MT using liquid aerosol propellant provides a micro-propulsion approach that performs similarly to a cold gas approach, which is low thrust (<1 mN) and Isp (50 s), or an electrospray approach, which is low thrust (<1 mN) and very high Isp (>1000 s). To increase thrust and provide small impulse bits, a multi-mode system is needed to combine these with monopropellant approach that is medium thrust (1-10 mN) and medium Isp (200 s). Using microfabrication, a MEMS-based VMA can be monolithically integrated to increase functionality and operate in multiple modes. For example, Joule-based μ-heaters can be integrated to reduce liquid viscosities to atomize higher viscous and high-density propellants to increase thrust and to function as a catalyst in a liquid monopropellant MT. Other added functionalities can include 1) integration of microfluidics chambers on the mesh membrane to i) atomize multiple liquids to create combustion from mixed aerosols, ii) switching between propellants for various modes of operation, 2) igniters using integrated metal electrodes to ignite the propellant as it leaves the nozzle, and 3) integrate top and bottom electrodes to create an electrospray MT using ionic propellants. The microfluidic chamber can allow multiple propellants to be used at the same time or can allow only a specific propellant to be used in a specific mode while switching to another propellant and mode. Each mode can use the VMA as the base mode of operation. This all-in-one multi-mode system can allow use of the advantages of each mode for specific applications. This all-in-one multi-mode system is only feasible using the MEMS VMA technology.

A Si-VMA, as disclosed herein, can be used in a system as a propulsion system having a highly accurate low-cost method for attitude control and maneuverability of Cubesats or micro-satellites with a goal of providing high thrust (>1 mN) and high Isp (>200 s). Multiphysics FEM and computational fluid dynamics (CFD) can be used to numerically optimize the various designs for each component. Such a system can include, along with the Si-VMA propulsion system, a Cubesat structure with commercial sensors, communication system, power system, for attitude control and precision maneuvering. Various modes may be combined I the operation of the Si-VMA propulsion system.

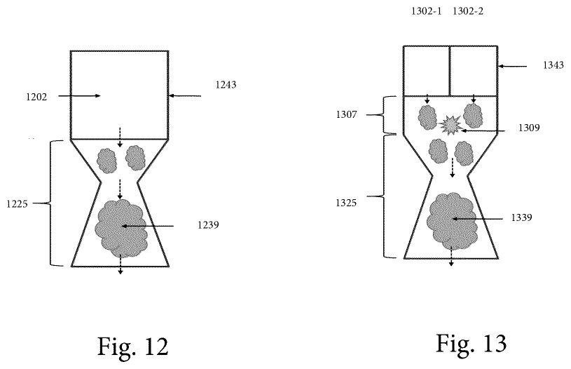

Each of the current individual MT modes current used have advantages and disadvantages. Spray mechanisms such as cold gas (spray of liquid or gas) and electrospray (ionization of ionic liquid) have high Isp but low thrust. Cold gas (CG) MT are relatively easy to fabricate. Liquid propellants typically cause combustion using a catalyst such as heat, ignition, or mixing of two chemicals that have high thrust but low Isp as shown in FIG. 11. FIG. 11 shows microthruster propulsion performance regions with respect to specific impulse versus thrust for several propulsion types. Performance region 1161 corresponds to electrospray(ES) for propulsion. Performance region 1162 corresponds to vaporizing liquid microthrusters (VLMs) that use the phase change of a liquid propellant to generate thrust. Performance region 1163 corresponds to a low-pressure micro-resistojet (LPM) propulsion system. This type of system is often used for nano-satellites and pico-satellites. Performance region 1164 corresponds to CG propulsion systems. Performance region 1166 corresponds to a liquid propellant (LP) system. Performance region 1167 corresponds to a solid propellant (SP) system. A system that can switch modes or operate in multiple modes can eliminate these disadvantages.

A Si-VMA can provide a single device in which a multi-mode MT can be integrated into a single device. The single device Si-VMA can have microfluidic chambers to handle multiple propellants and a switch mechanism to control which propellant works with each mode. The various components can be operated individually or together to create a novel propulsion mode.

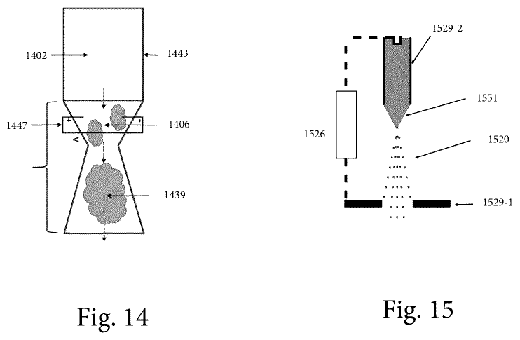

FIGS. 12-15 show schematics of propulsion modes for MTs. FIG. 12 illustrates a CG propulsion mode for a MT. The CG propulsion mode can include a propellent storage 1243 for compressed liquid/gaseous propellant 1202 and a nozzle 1225. Nozzle 1225 allows for expansion of decompressed propellant 1239. FIG. 13 illustrates a LP propulsion mode for a MT. The LP propulsion mode can include a propellent storage 1343 having liquid fuel storage 1322-1 and liquid oxidizer storage 1322-2. The LP propulsion mode includes use of a combustion chamber 1307 in combustion of liquid propellants 1309 occurs. The LP propulsion mode includes a nozzle 1325 that allows for expansion of burnt propellants 1339 and outputs products of combustion.

FIG. 14 illustrates a resistorjet propulsion mode for a MT. The resistorjet propulsion mode can include a propellent storage 1443 for compressed liquid/gaseous propellant 1402 and a nozzle 1425. The resistorjet propulsion mode can include use of a heating element 1447 providing heat for thermal excitation 1406. The resistorjet propulsion mode includes a nozzle 1325 that allows for expansion of decompressed propellant 1439 and outputs expanded propellant.

FIG. 15 illustrates an ES propulsion mode for a MT. The ES propulsion mode can include an upper electro 1529-2 and a lower electro 1529-1 coupled to a high voltage supply 1526. Use of high voltage supply 1526 provides a Taylor cone 1551 of ionic propellent at the end of upper electro 1529-2 that outputs a droplet spray 1520. A Taylor cone is a cone from which a jet of charged particles emanates above a threshold voltage in response to an electric field.

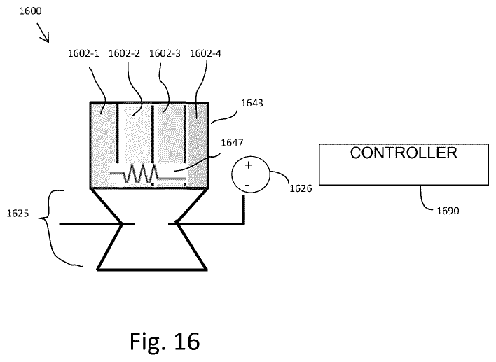

FIG. 16 illustrates an embodiment of an example MT 1600 with a Si-VMA having multiple thruster modes in a single device. By combining multiple modes into a single device, the limitations of individual MT modes either having high thrust with low specific impulse or high specific impulse with low thrust can be overcome. MT 1600 includes a nozzle 1625 that can be structured as an aperture of a mesh membrane of the Si-VMA. MT 1600 can include a large number of a nozzles that can be structured as apertures of the mesh membrane of the Si-VMA. A chamber 1643 can be integrated on and contacting the mesh membrane. Though chamber 1643 is shown on a single nozzle, chamber 1643 can be configured above the complete set of nozzles of the mesh membrane. Chamber 1643 can include four sub-chambers capable of holding four different propellants 1602-1, 1602-2, 1602-3, and 1602-4. Though four chambers for four propellants are shown in FIG. 16, chamber 1643 can have more or fewer than four chambers for four propellants. A micro-heater 1647 can be integrated into the Si-VMA of MT 1600. MT 1600 can include a voltage source 1626 to operate one or more MT modes. MT 1600 can include a controller 1690. Controller 1690 can control voltage source 1626 and micro-heater 1647 and can switch between different modes of operation.

The Si-VMA can provide a single device having multiple modes. The Si-VMA can provide a single device to have at least four modes. The four modes can include cold gas/liquid mode, combustible liquid propellant mode, resistorjet mode, and electrospray mode). The multiple modes can be realized by incorporating various electrodes at various locations on the membrane to create heaters for the resistorjet mode, ionization of liquid for the electrospray mode, and an ignition spark to create combustion. These different modes can be on a single membrane, or each membrane could have sections assigned to individual mode, where each mode uses a different liquid propellant different from other modes.

Approaches to implementing such MTs can involve developing and validating the multi-mode MEMS VMA MT. FEM and CFD can be used to numerically optimize and design the device and the various components such as a μ-heater and electrodes for igniter along with optimizing the nozzle design for wettability and droplet analysis. After the devices have been designed, they can be microfabricated using, but not limited to, silicon on insulator wafers using techniques as discussed herein with respect to Si-VMAs integrated with wicks.

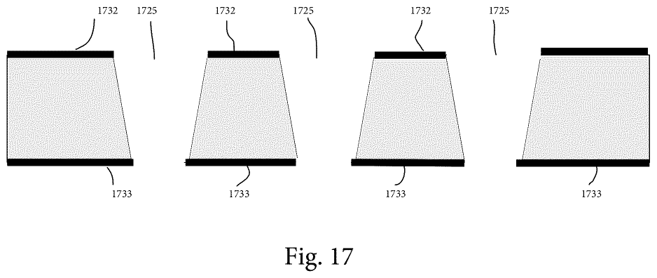

FIG. 17 illustrates an embodiment of an example electrospray electrode configuration in a Si-VMA. The electrode configuration includes electrodes 1732 as top electrodes on the mesh membrane of the Si-VMA about nozzles 1725 of the mesh membrane. The electrode configuration includes electrodes 1733 as bottom electrodes on the mesh membrane of the Si-VMA about nozzles 1725 of the mesh membrane. Electrodes 1733 configured as bottom electrodes on output of nozzles 1725 can be controlled as a group of electrodes or as individual electrodes.

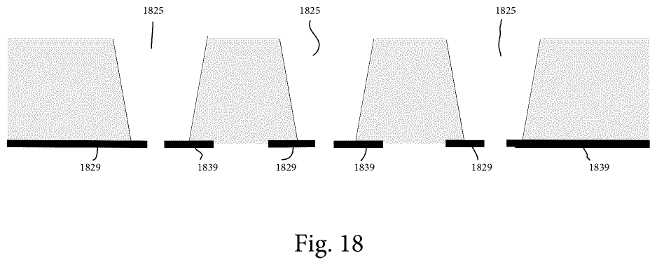

FIG. 18 illustrates an embodiment of an example combustion configuration for a Si-VMA having multiple nozzles 1825. Two electrodes, 1829 and 1839, are positioned close together about a nozzle 1825 to create a spark and cause ignition at the output of the Si-VMA. This arrangement provides an ignition mechanism with cathode 1829 and anode 1839.

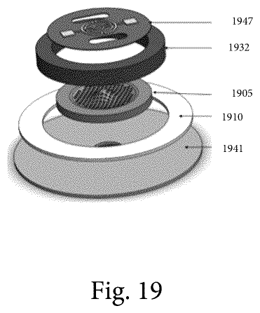

FIG. 19 illustrates an embodiment of an example resistorjet thruster configuration. The resistorjet thruster configuration can include a Si-VMA positioned on a holder 1941 and can include a mesh membrane 1905 to be actuated by a piezoelectric film 1910. Mesh membrane 205 can be a silicon mesh with holes (apertures) structured as nozzles. Piezoelectric film 1910 can have, but is not limited to, a ring structure coupled to mesh membrane 1905. A spacer 1932 can be positioned about or above mesh membrane 1905 along with a heater 1947. Heater 1947 can be a separate component on the mesh membrane 1905 or it can be monolithically fabricated on mesh membrane 1905.

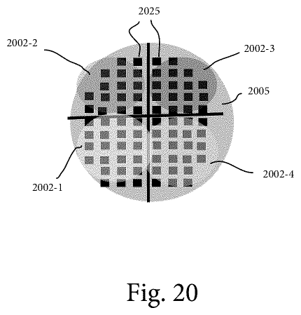

FIG. 20 is a top view of an embodiment of an example Si-VMA having a mesh membrane 2005 configured to accommodate four different MT modes and four different liquids. Mesh membrane includes nozzles 2025 to use the liquids to provide thrust. The different MT modes can include, but are not limited to, electro spray mode 2002-1, cold gas/liquid mode 2002-2, combustible propellant mode 2002-3, and resistorjet mode 2002-4. Alternatively, one liquid can be used with one mode per membrane.

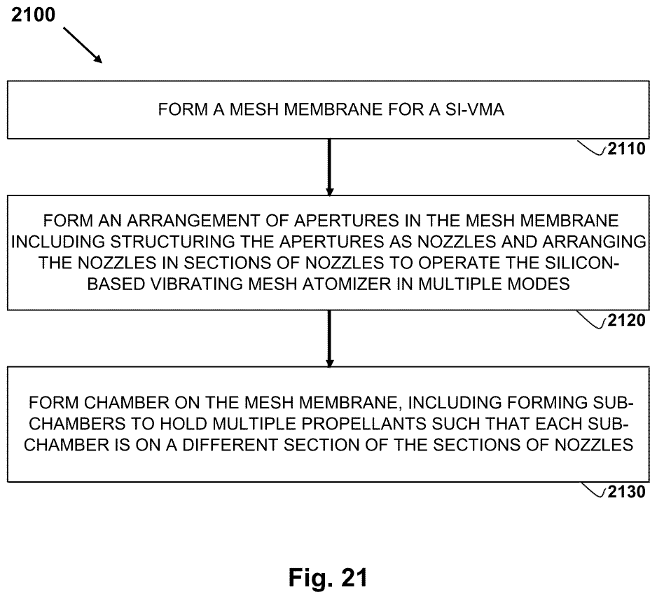

FIG. 21 is a flow diagram of features of an embodiment of an example method 2100 of forming a microthruster. At 2110, a mesh membrane is formed for a Si-VMA. At 2120, an arrangement of apertures is formed in the mesh membrane. The apertures are structured as nozzles and arranged in sections of nozzles to operate the Si-VMA in multiple modes for propulsion. At 2130, a chamber is formed on the mesh membrane, including forming sub-chambers to hold multiple propellants. The sub-chambers are structured such that each sub-chamber is on a different section of the sections of nozzles.

Variations of method 2100 or methods similar to method 2100 can include a number of different embodiments that may be combined depending on the application of such methods and/or the architecture of systems in which such methods are implemented. Such variations can include forming each sub-chamber on a section of nozzles structured to operate for a mode of the multiple modes different from modes for which other sections, corresponding to other sub-chambers, operate.

Variations of method 2100 or methods similar to method 2100 can include incorporating electrodes at locations in different sections on the mesh membrane to create a heater for a resistorjet mode, ionization of liquid for an electrospray mode, and an ignition spark to create combustion for a liquid propellant mode. Variations of method 2100 can include forming features associated with any of FIGS. 1 and 12-20.

In various embodiments, a microthruster includes a Si-VMA arranged as part of a multi-mode propulsion system. The Si-VMA can include a mesh membrane having an arrangement of apertures structured as nozzles, where the nozzles are arranged in sections of nozzles to operate the Si-VMA in the multiple modes. The microthruster can include a chamber on the mesh membrane having sub-chambers to hold multiple propellants such that each sub-chamber is on a different section of the sections of nozzles. The sub-chambers can be monolithically integrated with the Si-VMA.

Variations of such a microthruster or a similar microthruster can include a number of different embodiments that may be combined depending on the application of such a microthruster and/or the architecture of systems in which such microthrusters are implemented. Such microthrusters can include the nozzles being arranged in four sections. The nozzles can be arranged in at least two sections.

Variations of such a microthruster or a similar microthruster can include the multiple propellants being a gas to operate in a cold gas mode, a liquid to operate in a liquid propellant mode, a compressed liquid or gas to operate in a resistorjet mode, and a liquid to operate in an electrospray mode. Variations of such a microthruster or a similar microthruster can include a voltage source to operate in selected modes and a micro-heater to provide thermal excitation for at least one mode of operation. Electrodes can be incorporated at locations in different sections on the mesh membrane to create a heater for a resistorjet mode, ionization of liquid for an electrospray mode, and an ignition spark to create combustion for a liquid propellant mode.

Variations can include a heater integrated in the Si-VMA. Such a microthruster or a similar microthruster can include features associated with the structures of FIGS. 1 and 12-20.

MTs continue to be extensively investigated as they have a potentially significant impact in space exploration. As systems and payloads become smaller, propulsion systems also need to decrease in size, which brings numerous challenges. The creation of an all-in-one multi-mode system can lead to new opportunities. This can result in reduced launch costs, thus enabling more private companies to deploy systems into orbit. The Cubesat or satellites could reposition and maneuver to obtain more accurate information on the interested measurand. In addition, the MT, taught herein, could have an impact on future planetary observations in deep space and for planetary surface robotics or short-range drones.

Although specific embodiments have been illustrated and described herein, it can be appreciated by those of ordinary skill in the art that any arrangement that is calculated to achieve the same purpose may be substituted for the specific embodiments shown. Upon studying the disclosure, it will be apparent to those skilled in the art that various modifications and variations can be made in the devices and methods of various embodiments. Various embodiments can use permutations and/or combinations of embodiments described herein. Other embodiments will be apparent to those skilled in the art from consideration of the specification and practice of the embodiments disclosed herein. It is to be understood that the above description is intended to be illustrative, and not restrictive, and that the phraseology or terminology employed herein is for the purpose of description.

What is claimed is:

1. An apparatus comprising:
a silicon-based vibrating mesh atomizer having a mesh membrane, the mesh membrane having an arrangement of apertures structured as nozzles;
a mesh wick integrated with the silicon-based vibrating mesh atomizer and arranged on the mesh membrane.

2. The apparatus of claim 1, wherein the silicon-based vibrating mesh atomizer has electrodes to apply a voltage between a top of the mesh wick and a bottom of the mesh wick with the bottom of the mesh wick on and contacting the mesh membrane.

3. The apparatus of claim 1, wherein the mesh wick includes wick elements having an octahedral shape.

4. The apparatus of claim 3, wherein the mesh wick has multiple levels of mesh elements with a first level of mesh elements arranged with the octahedral shape structured to fit into a nozzle.

5. The apparatus of claim 1, wherein the mesh wick is structured as a single layer with wicking in between the nozzles on the mesh membrane.

6. The apparatus of claim 5, wherein the mesh wick includes cotton, nylon, or other absorbent material.

7. The apparatus of claim 1, wherein each nozzle of the nozzles of the mesh membrane has both a hydrophilic surface and a hydrophobic surface.

8. The apparatus of claim 7, wherein the hydrophilic surface is along an inner surface between an inlet of the nozzle and an outlet of the nozzle, and the hydrophobic surface is around the outlet of the nozzle.

9. The apparatus of claim 1, wherein the silicon-based vibrating mesh atomizer includes an integrated heater coupled to an electrode that is coupled to the mesh wick.

10. A method of an apparatus comprising:
forming a mesh membrane for a silicon-based vibrating mesh atomizer;
forming an arrangement of apertures in the mesh membrane including structuring the apertures as nozzles; and
forming a mesh wick arranged on the mesh membrane.

11. The method of claim 10, wherein the method includes coating the mesh wick in metal.

12. The method of claim 11, wherein coating the mesh wick includes using an electroless coating or using atomic layer deposition.

13. The method of claim 10, wherein the method includes structuring the nozzles to have both a hydrophilic surface and a hydrophobic surface.

14. A microthruster comprising:
a silicon-based vibrating mesh atomizer having a mesh membrane, the mesh membrane having an arrangement of apertures structured as nozzles, the nozzles arranged in sections of nozzles to operate the silicon-based vibrating mesh atomizer in multiple modes;
a chamber on the mesh membrane having sub-chambers to hold multiple propellants such that each sub-chamber is on a different section of the sections of nozzles.

15. The microthruster of claim 14, wherein the nozzles are arranged in four sections.

16. The microthruster of claim 15, wherein the multiple propellants include a gas to operate in a cold gas mode, a liquid to operate in a liquid propellant mode, a compressed liquid or gas to operate in a resistorjet mode, and a liquid to operate in an electrospray mode.

17. The microthruster of claim 14, wherein the microthruster includes a voltage source to operate in selected modes and a micro-heater to provide thermal excitation for at least one mode of operation.

18. A method of forming a microthruster, the method comprising:
forming a mesh membrane for a silicon-based vibrating mesh atomizer;
forming an arrangement of apertures in the mesh membrane including structuring the apertures as nozzles and arranging the nozzles in sections of nozzles to operate the silicon-based vibrating mesh atomizer in multiple modes; and
forming a chamber on the mesh membrane, including forming sub-chambers to hold multiple propellants such that each sub-chamber is on a different section of the sections of nozzles.

19. The method of claim 18, wherein forming the sub-chambers includes forming each sub-chamber on a section of nozzles structured to operate for a mode of the multiple modes different from modes for which other sections, corresponding to other sub-chambers, operate.

20. The method of claim 18, wherein the method includes incorporating electrodes at locations in different sections on the mesh membrane to create a heater for a resistorjet mode, ionization of liquid for an electrospray mode, and an ignition spark to create combustion for a liquid propellant mode.
